(19) United States
(12) Patent Application Publication
(10) Pub. No.: US 2026/0011825 A1
(43) Pub. Date: Jan. 8, 2026

(54) RECHARGEABLE BATTERY

(71) Applicant: TOYOTA BATTERY CO., LTD., Shizuoka (JP)

(72) Inventor: Yuji KATAYAMA, Okazaki-shi (JP)

(21) Appl. No.: 19/045,215

(22) Filed: Feb. 4, 2025

(30) Foreign Application Priority Data
Jul. 5, 2024 (JP) 2024-109016

(51) Int. Cl. H01M 50/103; H01M 10/0525; H01M 10/0587; H01M 50/121; H01M 50/15

(52) U.S. Cl. CPC H01M 50/103; H01M 10/0525; H01M 10/0587; H01M 50/121; H01M 50/15

(57) ABSTRACT

A rechargeable battery includes: a wound electrode body having a flat shape in which a positive electrode sheet and a negative electrode sheet are wound via a separator; and a case which is molded using an insulating resin and which stores therein the wound electrode body together with an electrolyte, in which the wound electrode body includes a pair of flat parts facing each other in the thickness direction of the wound electrode body, the case includes a first opposing surface and a second opposing surface which oppose a pair of flat surfaces being outer surfaces of the pair of flat parts, and at least one recessed part formed in at least one opposing surface of the first opposing surface and the second opposing surface, and the recessed part is capable of holding the electrolyte inside by surface tension.

### INCORPORATION BY REFERENCE

This application is based upon and claims the benefit of priority from Japanese patent application No. 2024-109016, filed on Jul. 5, 2024, the disclosure of which is incorporated herein in its entirety by reference for all purposes.

### BACKGROUND

The present disclosure relates to a rechargeable battery.

As an example of a rechargeable battery, Japanese Unexamined Patent Application Publication No. 2014-63632 discloses a battery with a power generation element and a case that houses the power generating element in a state of being immersed in an electrolyte. The case of the battery includes a container which opens at the top and a lid plate which is provided at a top end of side walls and which closes an opening of the container, and the container has a bottom wall and side walls that are erected from a peripheral edge of the bottom wall. In addition, the lid plate of the case has an electrolyte injection port for injecting the electrolyte into the interior of the case, and a groove which holds the electrolyte injected from the electrolyte injection port is formed on the inner surface of the side wall.

The technique described in Japanese Unexamined Patent Application Publication No. 2014-63632 proposes temporarily holding the electrolyte injected into the case inside the grooves during injection of the electrolyte so that more electrolyte can smoothly permeate the entire power generation element from side surfaces of the power generation element.

### SUMMARY

In such rechargeable batteries, a wound electrode body having a flat shape in which a positive electrode sheet and a negative electrode sheet are wound together via a separator may be used as the power generation element. In a rechargeable battery using a wound electrode body as the power generation element, expansion and contraction of the wound electrode body sealed inside the case and the generation of gases such as air from the wound electrode body as a result of charge and discharge generate pressure that pushes the case from inside to outside in a direction of thickness. When a counter-force against the pressure acts on the wound electrode body holding the electrolyte, the electrolyte is pushed out of the wound electrode body from the laminated surface where the positive electrode sheet, the negative electrode sheet, and the separator of the wound electrode body are laminated, causing the electrolyte to leak out from the wound electrode body.

The electrolyte having leaked from the wound electrode body flows down the inner surface of the side walls and collects at the bottom of the case. Furthermore, the electrolyte that collects at the bottom of the case permeates into the wound electrode body from the lamination surface.

However, if the electrolyte only penetrates into the wound electrode body from the lamination surface during charge and discharge, salt concentration of the electrolyte held in the wound electrode body may become uneven during repeated charge and discharge or an electrolyte dry-out may occur in which the battery runs out of electrolyte. Therefore, with the technique described in Japanese Unexamined Patent Application Publication No. 2014-63632, there is a problem in that internal resistance of the rechargeable battery may increase and cause a decline in battery performance. In particular, such problems are more pronounced in rechargeable batteries that undergo repeated high-rate charge and discharge.

The present disclosure has been made in consideration of the situation described above and an object thereof is to provide a rechargeable battery that can suppress a decline in battery performance due to lack of electrolyte held in a wound electrode body or due to electrolyte dry-out.

An aspect of the rechargeable battery according to the present disclosure includes: a wound electrode body having a flat shape in which a positive electrode sheet and a negative electrode sheet are wound via a separator; and a case which is molded using an insulating resin and which stores therein the wound electrode body together with an electrolyte, in which the wound electrode body includes a pair of flat parts facing each other in the thickness direction of the wound electrode body, the case includes a first opposing surface and a second opposing surface which oppose a pair of flat surfaces being outer surfaces of the pair of flat parts, and at least one recessed part formed in at least one opposing surface of the first opposing surface and the second opposing surface, and the recessed part is capable of holding the electrolyte inside by surface tension.

The rechargeable battery according to the present disclosure can suppress a decline in battery performance due to lack of electrolyte held in a wound electrode body or due to electrolyte dry-out.

The above and other objects, features and advantages of the present disclosure will become more fully understood from the detailed description given hereinbelow and the accompanying drawings.

### BRIEF DESCRIPTION OF DRAWINGS

FIG. 1 is a perspective view of a rechargeable battery according to a first embodiment;

FIG. 2 is an exploded perspective view of the rechargeable battery according to the first embodiment;

FIG. 3 is a sectional view taken along line III-III in FIG. 1;

FIG. 4 is a diagram for describing a correspondence relationship between a wound electrode body and an opposing surface in the rechargeable battery according to the first embodiment;

FIG. 5 is a diagram for describing a low-strength region of an opposing surface; and

FIG. 6 is a diagram for describing a pressure-bearing region of an opposing surface.

### DESCRIPTION OF EMBODIMENTS

In the following description and in the drawings, omissions and abridgments have been made when appropriate for the sake of clarity. In the respective drawings, same elements are denoted by same reference signs and repetitive descriptions are omitted as needed. In addition, in the following description, a direction in which a long side of a case 20 extends is defined as a width direction X, a direction in which a short side of the case 20 extends is defined as a thickness direction Z, and a direction which is orthogonal to the width direction X and the thickness direction Z and which represents a height of the case 20 is defined as a height direction Y. Furthermore, in the following description, the width direction X may be referred to as a left-right direction and the height direction Y may be referred to as an up-down direction. Leftward and downward refer to positive directions of the X axis and the Y axis, respectively.

### First Embodiment

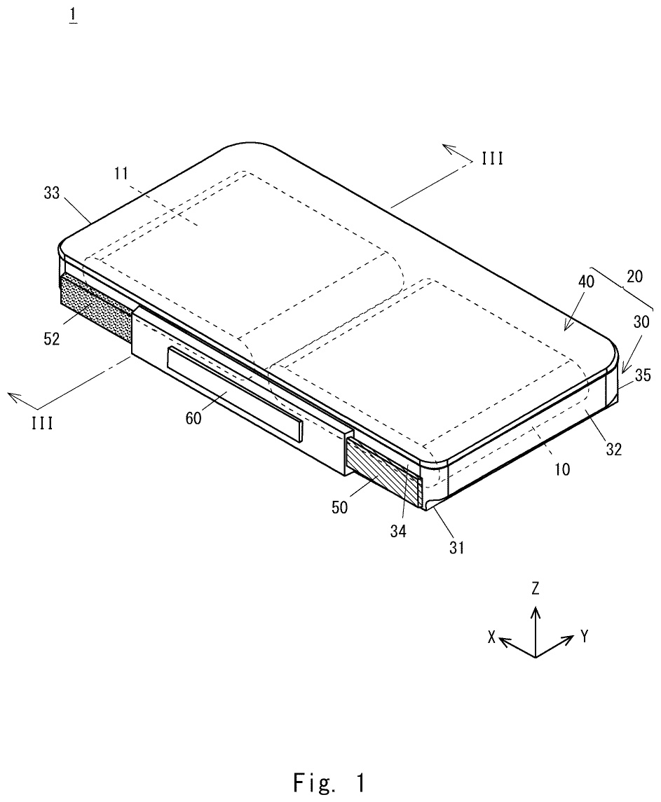

FIG. 1 is a perspective view of a rechargeable battery according to a first embodiment. A rechargeable battery 1 shown in FIG. 1 is a repetitively chargeable and dischargeable battery which uses a non-aqueous electrolytic solution as an electrolyte. In the present embodiment, a lithium-ion rechargeable battery will be described as an embodiment of the rechargeable battery 1. A lithium-ion rechargeable battery is a rechargeable battery which performs charge and discharge due to the movement of lithium ions which are charge carriers between a positive electrode and a negative electrode.

As shown in FIG. 1, the rechargeable battery 1 includes wound electrode bodies 10 and 11, a case 20, and an electrolyte (not illustrated). In the rechargeable battery 1 according to the first embodiment, two wound electrode bodies 10 and 11 are stored in one case 20, side by side in the width direction X of the case 20. In addition, the rechargeable battery 1 according to the first embodiment constitutes one battery cell with two electrode bodies connected in series. However, the number of electrode bodies stored in one case 20 is not particularly limited and may be one or three or more. Note that illustration of components other than the case 20 and the wound electrode bodies 10 and 11 stored in the case 20 have been omitted in FIG. 1.

The wound electrode bodies 10 and 11 are flat-shaped wound electrode bodies in which a positive electrode sheet and a negative electrode sheet are wound together via a separator. In the wound electrode bodies 10 and 11, an elongated positive electrode sheet and an elongated negative electrode sheet are laminated via two elongated sheet-like separators and are wound around a winding axis which is orthogonal to a longitudinal direction of the positive electrode sheet and the negative electrode sheet.

The positive electrode sheet that constitutes a positive electrode includes a positive electrode active material layer formed on at least one surface of an elongated positive electrode current collector. From the perspective of improving battery performance, the positive electrode active material layer is preferably formed on both surfaces of the positive electrode current collector. Materials that can be used in lithium-ion rechargeable batteries can be used without any particular restrictions as each member constituting the positive electrode sheet. As the positive electrode current collector, for example, a metal foil formed of a metal containing aluminum as a principal component can be used. The positive electrode active material layer contains a positive electrode active material that can reversibly absorb and release lithium ions which are charge carriers. As the positive electrode active material, for example, a lithium transition metal composite oxides such as a lithium nickel cobalt manganese composite oxide can be used. The positive electrode active material layer may contain an optional component other than the positive electrode active material. Examples of the optional component other than the positive electrode active material include, for example, a conductive material, a binder, and various additive components. As the conductive material, for example, a carbon material such as acetylene black (AB) can be used. As the binder, for example, polyvinylidene fluoride (PVdF) can be used.

The negative electrode sheet that constitutes a negative electrode includes a negative electrode active material layer formed on at least one surface of an elongated negative electrode current collector. From the perspective of improving battery performance, the negative electrode active material layer is preferably formed on both surfaces of the negative electrode current collector. Materials that can be used in lithium-ion rechargeable batteries can be used without any particular restrictions as each member constituting the negative electrode sheet. As the negative electrode current collector, for example, a metal foil formed of a metal containing copper as a principal component can be used. The negative electrode active material layer contains a negative electrode active material that can reversibly absorb and release charge carriers. As the negative electrode active material, for example, a carbon material such as graphite can be used. The negative electrode active material layer may contain an optional component other than the negative electrode active material. Examples of the optional component other than the negative electrode active material include, for example, a binder, a dispersant, and various additive components. As the binder, for example, rubbers such as styrene-butadiene rubber (SBR) can be used. As the dispersant, for example, celluloses such as carboxymethylcellulose (CMC) can be used.

The separator is provided between the positive electrode sheet and the negative electrode sheet so as to insulate the positive electrode sheet and the negative electrode sheet from each other. The separator holds the electrolyte. Separators that can be used in lithium-ion rechargeable batteries can be used without any particular restrictions as the separator. As the separator, a porous sheet formed of olefinic resin such as polyethylene (PE), polypropylene (PP), cellulose, or other resin can be used. The separator may have a single-layer structure or a multi-layer structure of two or more layers. For example, the multi-layer structure may be a three-layer structure in which a PP layer is laminated on both surfaces of a PE layer. In addition, a heat-resistant layer (HRL) may be formed on a surface of the separator.

The case 20 is an enclosure that houses the wound electrode bodies 10 and 11 inside along with the electrolyte. The case 20 has an outline with a rectangular parallelopiped shape that is flattened in the thickness direction Z. The case 20 is molded using an insulating resin. Using an insulating resin as the material of the case 20 enables complex shapes such as a recessed part 27 to be described later to be formed more easily than, for example, a case where metal is used as the material.

In the rechargeable battery 1 according to the first embodiment, the case 20 includes a case main body 30 and a lid 40. The case main body 30 is a box-like member with a rectangular parallelopiped shape that is flattened in the thickness direction Z. The case main body 30 includes a first side surface part 31, second side surface parts 32 and 33, a top surface part 34, and a bottom surface part 35. The first side surface part 31 opposes the lid 40 in the thickness direction Z of the case 20. The second side surface parts 32 and 33 extend in the thickness direction Z of the case 20 from a pair of opposing short sides of the first side surface part 31 toward the lid 40. The top surface part 34 and the bottom surface part 35 extend in the thickness direction Z of the case 20 from a pair of opposing long sides of the first side surface part 31 toward the lid 40.

The lid 40 is a plate-shaped member which is attached to the case main body 30 so as to close the opening of the case main body 30 and which has an approximately rectangular flat surface. The lid 40 seals the case main body 30 storing the wound electrode bodies 10 and 11. The lid 40 is bonded to an opening end part of the case main body 30. Accordingly, the case 20 is sealed.

Note that although an example where one lid 40 is provided with respect to two storage units 21 and 22 to be described later is described in the present embodiment, the lid 40 can be prepared as a separate member for each of the storage units 21 and 22. In this manner, by providing a lid for each of the storage units 21 and 22, advantageous effects can be obtained including being able to easily bond the lids to the case main body 30 and being able to change the shape of the lids according to the variation of each of the wound electrode bodies 10 and 11 and adjust a pressurization force to be applied to each of the wound electrode bodies 10 and 11.

Electrolytes that can be used in lithium-ion rechargeable batteries can be used without any particular restrictions as the electrolyte. The electrolyte is a composition of support salts in a non-aqueous solvent. As the non-aqueous solvent, non-protic solvents such as carbonates, esters, and ethers can be used. Among such non-protic solvents, carbonates such as ethylene carbonate (EC), diethyl carbonate (DEC), dimethyl carbonate (DMC), and ethyl methyl carbonate (EMC) can be suitably used as the non-aqueous solvent. Such non-aqueous solvents can be used alone or two or more non-aqueous solvents can be appropriately combined and used. As the support salts, for example, lithium salts such as LiPF₆, LiBF₄, and LiClO₄ can be suitably used. The electrolyte may contain additives as needed.

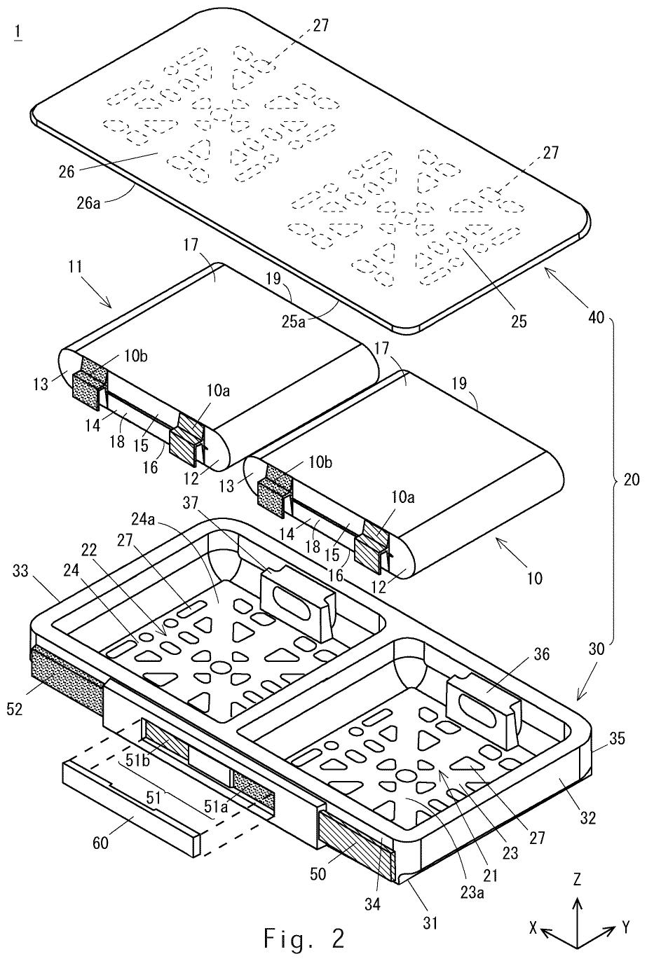

In addition to the wound electrode bodies 10 and 11, the case 20, and the electrolyte, the rechargeable battery 1 includes an external positive electrode terminal 50, an intermediate terminal 51 (refer to FIG. 2), an external negative electrode terminal 52, and an insulating cover 60.

Accordingly, FIG. 2 is an exploded perspective view of the rechargeable battery according to the first embodiment. As shown in FIG. 2, in the rechargeable battery 1 according to the first embodiment, the case main body 30 is insert-molded with the external positive electrode terminal 50, the intermediate terminal 51, and the external negative electrode terminal 52. In addition, the storage units 21 and 22 which store the wound electrode bodies 10 and 11 are formed in the case main body 30.

A positive electrode of the wound electrode body 10 is connected to the external positive electrode terminal 50. For example, the external positive electrode terminal 50 to which the positive electrode of the wound electrode body 10 is connected is formed of a metal containing aluminum as a principal component. A negative electrode of the wound electrode body 11 is connected to the external negative electrode terminal 52. For example, the external negative electrode terminal 52 to which the negative electrode of the wound electrode body 11 is connected is formed of a metal containing copper as a principal component.

The intermediate terminal 51 electrically connects a negative electrode of the wound electrode body 10 and a positive electrode of the wound electrode body 11 to each other. Specifically, the intermediate terminal 51 is formed by joining an intermediate negative electrode terminal 51a and an intermediate positive electrode terminal 51b to each other. For example, the intermediate negative electrode terminal 51a to which the negative electrode of the wound electrode body 10 is connected is formed of a metal containing copper as a principal component and the intermediate positive electrode terminal 51b to which the positive electrode of the wound electrode body 11 is connected is formed of a metal containing aluminum as a principal component. Furthermore, the intermediate terminal 51 is made by integrating the intermediate negative electrode terminal 51a and the intermediate positive electrode terminal 51b using a technique for dissimilar material bonding.

In the case main body 30, the external positive electrode terminal 50, the intermediate terminal 51, and the external negative electrode terminal 52 are arranged on a terminal arrangement surface that is an outer surface of the top surface part 34 so that the intermediate terminal 51 is located between the external positive electrode terminal 50 and the external negative electrode terminal 52.

In addition, in the case main body 30, resin is molded so that among the surfaces of the external positive electrode terminal 50 and the external negative electrode terminal 52, outer surfaces that face the outside of the case main body 30 and inner surfaces that face the storage units 21 and 22 are both exposed. Furthermore, in the intermediate terminal 51, resin is molded so that among the surfaces of the intermediate negative electrode terminal 51a and the intermediate positive electrode terminal 51b, outer surfaces that face the outside of the case main body 30 and inner surfaces that face the storage units 21 and 22 are both exposed. However, as shown in FIG. 2, the case main body 30 is molded so that the portion of the intermediate terminal 51 where the intermediate negative electrode terminal 51a and the intermediate positive electrode terminal 51b are joined to each other is covered with resin.

In this manner, since covering the junction surface of the intermediate negative electrode terminal 51a and the intermediate positive electrode terminal 51b with resin prevents the junction surface from being exposed to air, corrosion of the junction surface can be prevented.

The insulating cover 60 is provided at a position corresponding to the intermediate terminal 51. At least a surface of the insulating cover 60 is formed of an insulator. In one example, the insulating cover 60 is formed of an insulating material such as aluminum nitride. The insulating cover 60 has a shape that comes into contact with the intermediate negative electrode terminal 51a and the intermediate positive electrode terminal 51b that are exposed to the outside after resin formation. In this case, the insulating cover 60 preferably has a higher thermal conductivity than the resin that constitutes the case main body 30. Forming the insulating cover 60 with a material with a high thermal conductivity in this manner enables the insulating cover 60 to function as a heat-dissipating component that promotes the release of heat generated by the rechargeable battery 1. In other words, using a member that has high insulation and heat dissipation as the insulating cover 60 enables the insulating cover 60 to have both insulation and heat dissipation functions.

Furthermore, smoke exhaust ports 36 and 37 are formed so as to correspond to the storage units 21 and 22 in the case main body 30. The smoke exhaust ports 36 and 37 are provided on the inner surface of the bottom surface part 35 so as to face the storage units 21 and 22. The smoke exhaust ports 36 and 37 have a T-shape and are high enough that an upper surface with a large area is in contact with an end surface 19 that opposes an end surface 18 on which a positive electrode tab group 10a and a negative electrode tab group 10b of the wound electrode bodies 10 and 11 are formed. Using the smoke exhaust ports 36 and 37, the rechargeable battery 1 supports the end surfaces 19 of the wound electrode bodies 10 and 11 in the storage state with the members that constitute the smoke exhaust ports 36 and 37.

In addition, the smoke exhaust ports 36 and 37 are provided with holes that penetrate through a member formed in a shape capable of supporting the wound electrode bodies 10 and 11. Furthermore, an open valve (not illustrated) is provided in the holes to discharge gas inside the storage units 21 and 22 to the outside when the internal pressure of the storage units 21 and 22 rises. Due to the open valve, the rechargeable battery 1 is designed so that the internal pressure in the storage units 21 and 22 does not rise beyond a certain level.

The storage units 21 and 22 that are arranged side by side while being spaced apart in the width direction X of the case 20 are formed in the case main body 30. The wound electrode body 10 is stored in the storage unit 21 and the wound electrode body 11 is stored in the storage unit 22. In this storage state, the positive electrode tab group 10a of the wound electrode body 10 is joined to the external positive electrode terminal 50. The negative electrode tab group 10b of the wound electrode body 10 is joined to the intermediate negative electrode terminal 51a. In addition, in this storage state, the positive electrode tab group 10a of the wound electrode body 11 is joined to the intermediate positive electrode terminal 51b. The negative electrode tab group 10b of the wound electrode body 11 is joined to the external negative electrode terminal 52.

In the rechargeable battery 1 according to the first embodiment, after storing the wound electrode bodies 10 and 11 in the storage units 21 and 22, the electrolyte is injected into the storage units 21 and 22 from each opening to impregnate the wound electrode bodies 10 and 11 with the electrolyte. Subsequently, the rechargeable battery 1 can be manufactured by bonding the lid 40 to the case main body 30 so as to cover each opening of the storage units 21 and 22.

In the rechargeable battery 1 manufactured in this manner, the external positive electrode terminal 50, the intermediate terminal 51, and the external negative electrode terminal 52 are arranged in a straight line on a same surface. Therefore, a current path in the rechargeable battery 1 passes through the wound electrode bodies 10 and 11 close to the terminal arrangement surface and is formed by a path with less meandering with respect to the terminal arrangement surface. Accordingly, the rechargeable battery 1 according to the first embodiment enables resistance to be reduced as a battery.

The flat-shaped wound electrode bodies 10 and 11 include curved parts 12 and 13 whose outer surfaces are curved and flat parts 14 and 15 whose outer surfaces that connect the curved parts 12 and 13 are flat. The flat parts 14 and 15 oppose each other in the thickness direction of the wound electrode bodies 10 and 11. The wound electrode bodies 10 and 11 configured in this manner include flat surfaces 16 and 17 which are outer surfaces of the flat parts 14 and 15 and the end surfaces 18 and 19 which are orthogonal to the winding axis of the wound electrode bodies 10 and 11. The flat surfaces 16 and 17 have an approximately rectangular shape. The end surfaces 18 and 19 are lamination surfaces where a positive electrode sheet, a negative electrode sheet, and a separator are laminated and are opened to the outside of the wound electrode bodies 10 and 11.

The wound electrode bodies 10 and 11 are stored in the storage units 21 and 22 in an orientation where the winding axis of the wound electrode bodies 10 and 11 is parallel to the height direction Y of the case 20. In the wound electrode bodies 10 and 11 stored in the storage units 21 and 22, the curved parts 12 and 13 are arranged on both sides of the width direction X of the case 20 and the flat parts 14 and 15 are arranged on both sides of the thickness direction Z of the case 20.

The case 20 includes four opposing surfaces 23a, 24a, 25a, and 26a which oppose the flat surfaces 16 and 17 of the wound electrode bodies 10 and 11. The opposing surfaces 23a and 24a and the opposing surfaces 25a and 26a oppose each other in the thickness direction Z of the case 20.

In the rechargeable battery 1 according to the first embodiment, the case main body 30 includes the opposing surfaces 23a and 24a as first opposing surfaces which oppose the respective flat surfaces 16 of the wound electrode bodies 10 and 11 and the lid 40 includes the opposing surfaces 25a and 26a as second opposing surfaces which oppose the respective flat surfaces 17 of the wound electrode bodies 10 and 11.

In addition, the case 20 includes a plurality of recessed parts 27 formed on the opposing surfaces 23a, 24a, 25a, and 26a. The opposing surfaces 23a and 24a are inner surfaces of first opposing parts 23 and 24 which oppose the flat part 14 in the first side surface part 31. The opposing surfaces 25a and 26a are inner surfaces of second opposing parts 25 and 26 which oppose the flat part 15 in the lid 40. The opposing surfaces 23a, 24a, 25a, and 26a face the storage units 21 and 22. The recessed parts 27 are holes that are depressed toward the outside of the thickness direction Z of the case 20 from the opposing surfaces 23a, 24a, 25a, and 26a.

As the rechargeable battery 1 configured in this manner is charged and discharged, the wound electrode bodies 10 and 11 sealed inside the case 20 expand and contract and gases such as air are generated from the wound electrode bodies 10 and 11. When the rechargeable battery 1 is charged and discharged, the wound electrode bodies 10 and 11 in the case 20 expand and contract in the thickness direction of the wound electrode bodies 10 and 11 due to absorption and release of lithium ions.

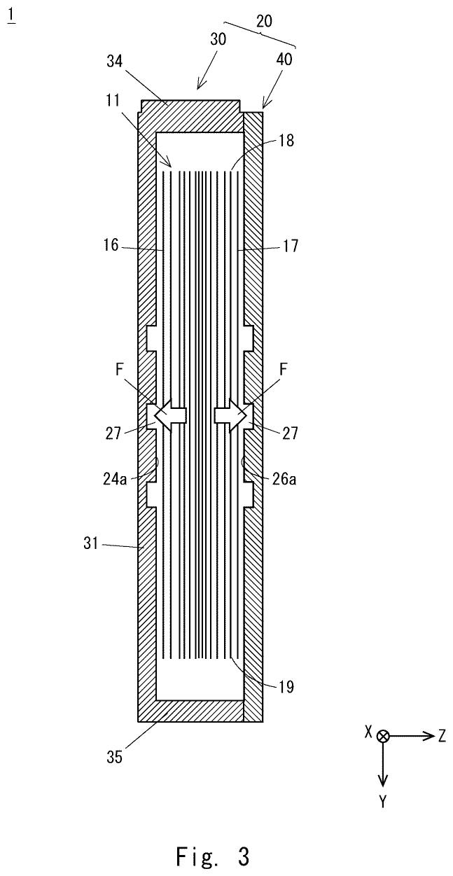

Next, FIG. 3 is a sectional view taken along line III-III in FIG. 1. Note that while illustration of the case 20 and the components stored inside the case 20 other than the wound electrode body 11 have been omitted in FIG. 3, a structure on the side of the wound electrode body 10 stored in the case 20 is similar to the structure on the side of the wound electrode body 11 stored in the case 20 shown in FIG. 3. Here, problems that may occur during charge and discharge of the rechargeable battery 1 will be described using the structure on the side of the wound electrode body 11 stored in the case 20 as an example.

As shown in FIG. 3, in the rechargeable battery 1, when the wound electrode body 11 in the case 20 expands or a gas is generated from the wound electrode body 11, pressure F that pushes the case 20 from inside to outside in the thickness direction Z is created. In addition, when a counter-force against the pressure F acts on the wound electrode body 11 holding the electrolyte, since the electrolyte is pushed out of the wound electrode body 11 from the end surfaces 18 and 19, the electrolyte leaks out from the wound electrode body 11.

The electrolyte having leaked from the wound electrode body 11 flows down the opposing surfaces 24a and 26a to the bottom part of the case 20 and collects there. Furthermore, the electrolyte that collects at the bottom part of the case 20 permeates into the wound electrode body 11 from the end surface 19. In this manner, the electrolyte having leaked out from the wound electrode body 11 is reabsorbed by the wound electrode body 11 via the end surface 19.

However, since the pressure F generated by the expansion of the wound electrode body 11 increases with repeated charge and discharge, the reaction force against the pressure F also increases. Therefore, if the electrolyte only penetrates into the wound electrode body 11 from the end surface 19 during charge and discharge, salt concentration of the electrolyte held in the wound electrode body 11 may become uneven or an electrolyte dry-out may occur in which the battery runs out of electrolyte during repeated charge and discharge. If the salt concentration of the electrolyte held in the wound electrode body 11 becomes uneven or if an electrolyte dry-out occurs in which the battery runs out of electrolyte, a problem arises in that the internal resistance of the rechargeable battery 1 may increase and battery performance may decline.

In consideration thereof, in the rechargeable battery 1 according to the first embodiment, the recessed part 27 is capable of holding the electrolyte therein by surface tension. The recessed part 27 temporarily holds the electrolyte introduced therein while the electrolyte having leaked from the wound electrode body 11 flows down the opposing surfaces 24a and 26a to the bottom part of the case 20. The electrolyte held in the recessed part 27 is supplied to the wound electrode body 11 when the flat surfaces 16 and 17 come into contact with the opposing surfaces 24a and 26a. Furthermore, the electrolyte that is supplied from the case 20 permeates into the wound electrode body 11 from the flat surfaces 16 and 17. In this manner, the electrolyte having leaked out from the wound electrode body 11 is reabsorbed by the wound electrode body 11 via the flat surfaces 16 and 17.

Therefore, in the rechargeable battery 1 according to the first embodiment, the wound electrode body 11 can reabsorb more electrolyte because the electrolyte permeates into the wound electrode body 11 not only from the end surface 19 but also from the flat surfaces 16 and 17 during charge and discharge. Accordingly, situations where the concentration of the electrolyte held in the wound electrode body 11 becomes uneven and an electrolyte dry-out occurs in which the battery runs out of electrolyte can be suppressed. As a result, a decline in battery performance due to lack of electrolyte held in the wound electrode body 11 or due to electrolyte dry-out can be suppressed.

In the rechargeable battery 1 according to the first embodiment, as shown in FIG. 2, the case main body 30 includes the opposing surfaces 23a and 24a and the lid 40 includes the opposing surfaces 25a and 26a. In addition, the opposing surfaces 23a and 24a that are adjacent to each other are configured to be bilaterally symmetrical and the opposing surfaces 25a and 26a that are adjacent to each other are also configured to be bilaterally symmetrical. Furthermore, the opposing surfaces 23a and 24a and the opposing surfaces 25a and 26a are configured to be vertically symmetrical. Therefore, hereinafter, details of the recessed part 27 will be described using the opposing surface 24a as an example.

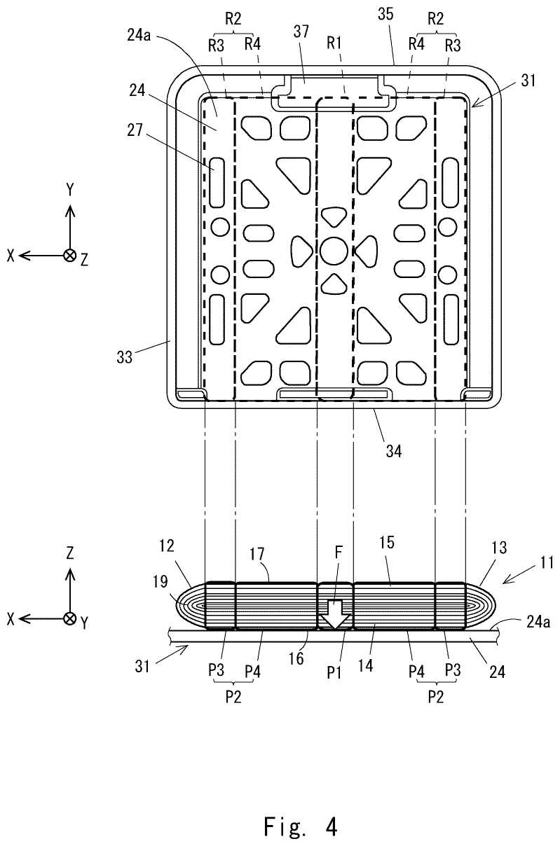

FIG. 4 is a diagram for describing a correspondence relationship between a wound electrode body and an opposing surface in the rechargeable battery according to the first embodiment. An upper side of FIG. 4 shows a portion of the first side surface part 31 and its surroundings as viewed from the side of the opposing surface 24a. A lower side of FIG. 4 shows the wound electrode body 11 and a portion of the first side surface part 31 as viewed from the side of the end surface 19.

First, one or more recessed parts 27 need only be formed on the opposing surface 24a and a plurality may be formed as shown in FIG. 4. From the perspective of having the wound electrode body 11 reabsorb a larger amount of the electrolyte, a plurality of recessed parts 27 are preferably formed on the opposing surface 24a.

In addition, a shape of the recessed part 27 is not particularly limited. The shape of the recessed part 27 may be a cone, a triangular pyramid, a square pyramid, a polygonal pyramid, a conical base, a triangular pyramid, a square pyramid, a polygonal pyramid, or the like or, as shown in FIG. 4, a columnar shape such as a circular column, a triangular column, a square column, or a polygonal column with an approximately constant cross-sectional shape in the height direction of the recessed part 27. The plurality of recessed parts 27 may be all the same or different in shape and size, or may be partly the same in shape and size as shown in FIG. 4. Note that the height direction of the recessed part 27 is a direction that is parallel to the thickness direction Z of the case 20.

A mass of the electrolyte held inside the recessed part 27 is obtained from a balance between the surface tension of the electrolyte held inside the recessed part 27 and gravitational force, using expression (1) below.

$$Wg = LT cos θ \qquad Expression ( 1 )$$

In expression (1), W denotes a mass of the electrolyte held inside the recessed part 27 (kg), g denotes gravitational force (m/s²), L denotes a circumferential length of the opening of the recessed part 27 (m), T denotes a surface tension of the electrolyte (N/m), and θ denotes a contact angle between the electrolyte and the opening of the recessed part 27. Note that the circumferential length L can be obtained from a circular-equivalent diameter of the opening of the recessed part 27. An equivalent circle corresponding to the opening of the recessed part 27 is favorably an inscribed circle inside the opening of the recessed part 27.

As shown in expression (1) above, the mass W is determined by the circumferential length L.

In addition, the mass W is obtained using expression (2) below.

$$W = Ah ρ \qquad Expression ( 2 )$$

In expression (2), A denotes an opening area of the recessed part 27 (m²), h denotes a height of the recessed part 27 (m), and ρ denotes a density of the electrolyte (kg/m³). In addition, Ah denotes a volume (mm³) of the recessed part 27.

As shown in expression (2) above, the mass W is a product of the volume Ah of the recessed part 27 and the density ρ.

Furthermore, from the expressions (1) and (2) above, the height h can be obtained by expression (3) below.

$$h = LT cos θ / A ρ g \qquad Expression ( 3 )$$

In addition, from the perspective of suppressing a decline in the strength of the case 20, the recessed part 27 preferably has a height appropriate to the strength of the case 20.

Furthermore, the recessed part 27 preferably has an opening circumferential length L of 25.5 mm or less and a volume of 41.5 mm³ or less. Accordingly, the recessed part 27 can reliably hold the electrolyte.

Next, the correspondence relationship between the wound electrode body 11 and the opposing surface 24a will be described. The flat parts 14 and 15 are configured to be symmetrical in the thickness direction of the wound electrode body 11. The flat parts 14 and 15 include a central part P1 and a pair of outer parts P2. The central part P1 includes a center line in a winding direction that is orthogonal to the winding axis direction and the thickness direction of the wound electrode body 11 and has a predetermined width in the winding direction. From the perspective of suppressing expansion of the wound electrode body 11, the predetermined width favorably ranges from, for example, 15 to 30% of the width of the wound electrode body 11. The outer parts P2 are positioned on outer sides of the central part P1 in the winding direction. In addition, the outer parts P2 are adjacent to the central part P1. Furthermore, the outer parts P2 each include an end part P3 in the winding direction and an intermediate part P4 between the central part P1 and the end part P3.

In addition, the opposing surface 24a includes a central region R1 and a pair of outer regions R2. The central region R1 extends in the height direction Y as a first direction that is parallel to the winding axis direction so as to correspond to the central part P1. The outer regions R2 are positioned on outer sides of the central region R1 in the width direction X as a second direction that is parallel to the winding direction so as to correspond to the outer parts P2. In addition, the outer regions R2 are adjacent to the central region R1.

Furthermore, the outer regions R2 each include an end region R3 and an intermediate region R4 as a plurality of regions created by dividing the outer regions R2 in the width direction X. The end regions R3 and the intermediate regions R4 are arranged side by side in the width direction X and respectively extend in the height direction Y. The end regions R3 are positioned on outer sides of the regions R4 in the width direction X so as to correspond to the end parts P3. The intermediate regions R4 are positioned on outer sides of the central region R1 in the width direction X so as to correspond to the intermediate parts P4.

In this case, the flat parts 14 and 15 are subjected to a greater reaction force from the first side surface part 31 the closer they are to the center line in the winding direction that is parallel to the width direction X. Therefore, as shown in FIG. 4, when the outer regions R2 are divided into two parts in the width direction X, the total volume of the recessed parts 27 formed in the end regions R3 is smaller than the total volume of the recessed parts 27 formed in the intermediate regions R4.

In this manner, the total volume of the recessed parts 27, each of which is formed in each of the plurality of regions that divide the outer regions R2 in the width direction X is preferably smaller the further outward in the width direction X from the central region R1. Accordingly, since a larger amount of the electrolyte permeates the portions of the flat parts 14 and 15 that are subjected to greater reaction force from the first side surface part 31, a decline in battery performance due to lack of electrolyte retained in the wound electrode body 11 or due to electrolyte dry-out can be further suppressed.

In addition, since the central region R1 of the opposing surface 24a is subjected to the greatest pressure F in the opposing surface 24a, the central region R1 bends the most due to the pressure F. In consideration thereof, from the perspective of suppressing a decline in the strength of the case 20, a total volume of the recessed parts 27 formed in the central region R1 is preferably smaller than the total volume of the recessed parts 27 formed in the end regions R3 which are the outermost regions in the width direction X.

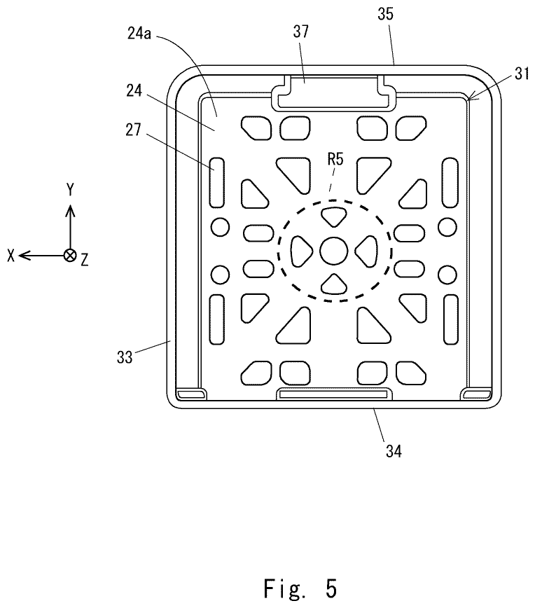

Next, FIG. 5 is a diagram for describing a low-strength region of an opposing surface. As shown in FIG. 5, the opposing surface 24a includes a low-strength region R5. The low-strength region R5 is an approximately circular region that surrounds a center of the opposing surface 24a. The low-strength region R5 has a lower strength than the other regions of the opposing surface 24a. In consideration thereof, from the perspective of suppressing a decline in the strength of the case 20, the volume of the recessed parts 27 per unit area of the low-strength region R5 having a lower strength than the other regions of the opposing surface 24a is preferably smaller than the volume of the recessed parts 27 per unit area of the other regions.

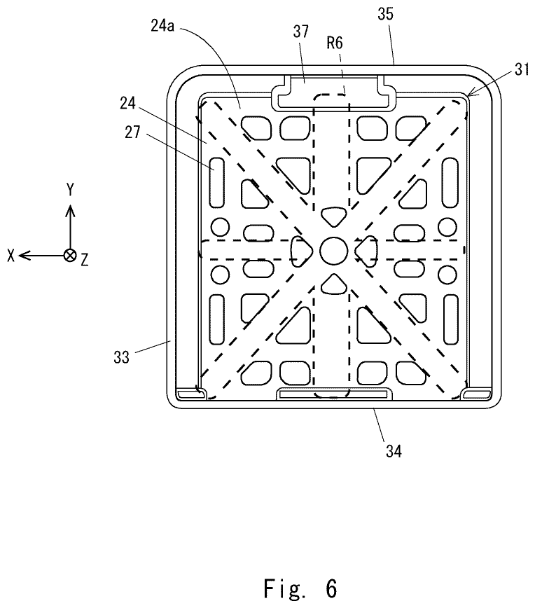

Next, FIG. 6 is a diagram for describing a pressure-bearing region of an opposing surface. As shown in FIG. 6, the opposing surface 24a includes a pressure-bearing region R6. The pressure-bearing region R6 extends radially from the center of the opposing surface 24a along each of the diagonals of the opposing surface 24a, the center line in the width direction X, and the center line in the height direction Y. Since the pressure-bearing region R6 is subjected to greater pressure F than the other regions of the opposing surface 24a, the pressure-bearing region R6 bends more due to the pressure F. In consideration thereof, from the perspective of suppressing a decline in the strength of the case 20, the volume of the recessed parts 27 per unit area of the pressure-bearing region R6 is preferably smaller than the volume of the recessed parts 27 per unit area of the other regions.

As described above, with the rechargeable battery 1 according to the first embodiment, forming the recessed parts 27 in consideration of the strength of the case 20 enables a decline in battery performance due to lack of electrolyte held in the wound electrode body 11 or due to electrolyte dry-out to be suppressed while securing the strength of the case 20.

The present disclosure is not limited to the embodiments described above and can be appropriately modified without deviating from the scope and spirit of the disclosure. For example, while a mode in which the total volumes of the recessed parts 27 formed on the respective opposing surfaces are the same has been described above, a mode may be adopted in which the total volumes of the recessed parts 27 formed on the respective opposing surfaces differ from each other.

In addition, while a mode in which the recessed parts 27 are formed on all of the plurality of opposing surfaces included in the case main body 30 and the lid 40 has been described above, the recessed parts 27 need only be formed on at least one opposing surface among the plurality of opposing surfaces.

Furthermore, while the case 20 including the case main body 30 which has one end in the thickness direction Z opened and the lid 40 which closes the opening has been described above, a mode may be adopted in which the case 20 includes a case main body which has one end in the height direction Y opened and a lid which closes the opening. In this case, the case main body includes at least one opposing surface but the lid does not include any opposing surface.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A rechargeable battery, comprising:
a wound electrode body having a flat shape in which a positive electrode sheet and a negative electrode sheet are wound via a separator; and
a case which is molded using an insulating resin and which stores therein the wound electrode body together with an electrolyte, wherein
the wound electrode body includes a pair of flat parts facing each other in the thickness direction of the wound electrode body,
the case includes
a first opposing surface and a second opposing surface which oppose a pair of flat surfaces being outer surfaces of the pair of flat parts, and
at least one recessed part formed in at least one opposing surface of the first opposing surface and the second opposing surface, and
the recessed part is capable of holding the electrolyte inside by surface tension.

2. The rechargeable battery according to claim 1, wherein
the case includes
a case main body which stores the wound electrode body, and
a lid which seals the case main body storing the wound electrode body,
the case main body includes the first opposing surface, and
the lid includes the second opposing surface.

3. The rechargeable battery according to claim 1, wherein the recessed part has an opening circumferential length of 25.5 mm or less and a volume of 41.5 mm³ or less.

4. The rechargeable battery according to claim 1, wherein
the flat parts each include
a central part including a center line in a winding direction that is orthogonal to a winding axis direction and the thickness direction of the wound electrode body and which has a predetermined width in the winding direction, and
a pair of outer parts which are positioned on outer sides of the central part in the winding direction,
the opposing surfaces include
a central region which extends in a first direction that is parallel to the winding axis direction so as to correspond to the central part, and
a pair of outer regions which is positioned on outer sides of the central region in a second direction that is parallel to the winding direction so as to correspond to the pair of outer parts, and
a total volume of the recessed parts formed in each of the plurality of regions dividing the outer regions in the second direction is smaller in the regions farther outward in the second direction from the central region.

5. The rechargeable battery according to claim 4, wherein a total volume of the recessed parts formed in the central region is smaller than a total volume of the recessed parts formed in the regions positioned most outward in the second direction.

6. The rechargeable battery according to claim 1, wherein a volume of the recessed parts per unit area of a low-strength region with a strength lower than other regions of the opposing surfaces is smaller than a volume of the recessed parts per unit area of the other regions.

7. The rechargeable battery according to claim 1, wherein a volume of the recessed parts per unit area of a pressure-bearing region which is subjected to greater pressure than the other regions of the opposing surfaces is smaller than a volume of the recessed parts per unit area of the other regions.
